(19) United States
(12) Patent Application Publication
(10) Pub. No.: US 2008/0178396 A1
(43) Pub. Date: Jul. 31, 2008

(54) Rinse-cleaning laundry washing machine method

(76) Inventors: Josephus Hendrikus Petrus van der Linden, Beijing (CN); Alain Lievens, Rumst (BE); Sabine Ursula Metzer-Groom, Tervuren (BE); Francesco de Buzzaccarini, Breendonk (BE); James Charles Theophile Roger Burckett St. Laurent, Brussels (BE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/906,448

(22) Filed: Oct. 2, 2007

Related U.S. Application Data
(60) Provisional application No. 60/849,979, filed on Oct. 6, 2006.
(60) Provisional application No. 60/901,792, filed on Feb. 16, 2007.

(51) Int. Cl. D06B 5/00; C11D 3/37; C11D 3/60; D06F 39/02; D06M 15/70

(52) U.S. Cl. 8/137; 510/347; 510/276; 8/159

(57) ABSTRACT

Methods of laundering textiles, comprising the sequential steps of: A) adding into a drum of a domestic front-loading laundry washing machine, wherein said washing machine has at least one rinse and spin program, at least: i) one or more textiles; and ii) a detergent composition; B) actuating the washing machine to perform at least one rinse and spin program, wherein the actuation of such rinse and spin program is not immediately preceded by a wash of said textiles; and C) removing the textiles from the washing machine.

### CROSS REFERENCE TO RELATED APPLICATIONS

This application claims the benefit of U.S. Provisional Application Ser. No. 60/849,979, filed Oct. 6, 2006 (P&G Case 10592P), and U.S. Provisional Application Ser. No. 60/901,792, filed Feb. 16, 2007 (P&G Case 10592P2).

### FIELD OF THE INVENTION

The present invention relates to methods of using domestic front-loading laundry washing machines to clean textiles, especially soiled clothing, and to laundry cleaning compositions for use therewith.

### BACKGROUND OF THE INVENTION

In the European Union as of 2004, there existed an installed base of more than 100 million domestic laundry washing machines. These are used for cleaning consumer textiles, e.g., clothing, garments, linens, curtains, and other fabrics. By far, the majority of these laundry washing machines are front-loading, as distinct from the “top-loading” or “vertical axis” configuration which has, until recently, been more common in North America and Asia. The term “horizontal axis” has often been used interchangeably to refer to “front-loading” laundry washing machines.

The replacement rate of laundry washing machines is very slow in most EU countries, in particular in France and Germany. A majority of these laundry washing machines are replaced only once every ten to fifteen years.

Domestic laundry washing machines are generally provided with a series of “programs”. A “program” typically includes at least two steps with respect to basic operations of the machine such as opening or closing valves to fill or to drain water from the appliance, switching a heater on or off, and the like. Washing programs can for example include filling of the machine drum with water, agitating the contents of the drum, draining the aqueous content of the drum, and spinning the drum to remove additional aqueous content. The term “cycle” is sometimes also used, in general a “cycle” can be considered the result achieved by completing a program comprising multiple steps such as filling, agitating, draining, spinning and the like.

A “full laundering” program for soiled textiles (such as a “60 degree cotton” program) conducted in a front-loading domestic laundry washing machine generally includes, at minimum, a washing stage of filling and agitating, multiple rinses and spinning. Often a “pre-wash” program is provided which can be user selectable as a stand-alone program or which can be selectable for additional agitation preceding a separately selected main program. The weight of clothing laundered is typically at least half of the rated load of the washing machine, and is often a full load, e.g., about 5 kg.

Domestic front-loading laundry washing machines generally use less water and energy than top-loading types, but the “full laundering” programs of front-loading machines generally are quite lengthy compared to top-loading machines. Front-loading machines typically take well over 100 minutes and may take up to two hours or more, to run a standard “full” laundering program. Even low-heat programs such as wool or delicate programs can take well over 30 minutes to run. An additional downside to front-loading laundry washing machines is that such long washes tend to damage textiles more than short washes due to the additional physical stress of longer agitation.

It is well-established that consumers would like to be able to quickly, efficiently, and safely (from the standpoint of fabric damage) wash their clothes, especially favorite items. In many cases, there is a need to rapidly wash a few favorite items, which are not necessarily heavily stained but rather, have merely been worn for a few hours and have developed an undesirable odor or tactile feel (e.g., consumer believes there is a need for “refreshing” before wearing again). For these lightly used items, the lengthy standard program seems especially wasteful to consumers.

In order to solve some of the problems with lengthy laundering programs, appliance manufacturers are slowly introducing domestic laundry washing machines which offer a wider range of washing programs. Such programs may include those that are identified by manufacturers on the washer control panel as “Quick Wash” or “Super Quick” programs. However, these new machines do not fully address the consumer identifiable problems. First, consumers typically dislike too much appliance complexity in program options, and secondly, such programs are only “quick” compared to the normal over-an-hour programs used in Western Europe. Most take 30 minutes or more to run. One exception is that Bosch has recently introduced a “Super Quick” program said to be able to launder 2 kg of lightly soiled clothing in 15 minutes. During these new programs, water is typically routed to a detergent dispenser drawer of the washing machine as in the case of normal full wash programs. Heating is used, even if the wash temperatures may be only 30 to 60° C.

However, no matter the solutions offered by newly manufactured machines, it will take years to achieve the market penetration needed to accomplish these purposes by an appliance replacement approach. Consumers do not always wish to rid themselves of adequately functioning washing machines, even if they are older machines, since they are increasingly aware of the problem of appliance waste, and indeed, may in Europe be required to pay taxes on such waste or may be prevented from treating used appliances as waste—see European directive 2002/96/EC on Waste Electrical and Electronic Equipment (WEEE).

In the meantime, with respect to the existing base of installed appliances, consumers remain frustrated with the generally long wash times provided by normal wash programs. They wish to obtain better control of washing in their existing washing machines and to obtain rapid yet effective laundering of fabrics with minimum damage, especially of preferred items of clothing.

Therefore, in the existing base of washing machines in the EU, a strong need exists to provide consumers with improved methods of use for their current European-style domestic (front-loading and/or horizontal axis) laundry washing machines. Likewise, there exists a need for new laundry product systems, and instructions for their use, which can be conducive to promote such efficiency. The societal benefits in terms of water and energy savings could be considerable, and consumers would benefit since their favorite garments could be frequently washed while retaining superior fabric care e.g., textile softness, feel or handle, elasticity retention, antistatic benefits, color retention benefits and a range of other benefits e.g., improved hygiene, skin feel benefits, hedonic benefits and the like.

### SUMMARY OF THE INVENTION

It has now surprisingly been discovered that it is possible to launder soiled or lightly worn textiles, by treating the textiles in rinse-and-spin programs of the installed base of domestic front-loading laundry washing machines, even when such cycles are not identified and/or designed for laundering soiled clothes, but rather have been provided by appliance manufacturers for other purposes, for example rinsing and spinning clothes which have already been washed by hand without use of the machine.

Accordingly, in one aspect, the present invention relates to a method of laundering textiles, comprising the sequential steps of:
A) adding into a domestic front-loading laundry washing machine, wherein said washing machine has at least one rinse and spin program, at least:
   i) one or more textiles; and
   ii) a detergent composition;
B) actuating the washing machine to perform at least one rinse and spin program, wherein the actuation of such rinse and spin program is not preceded by a manual or machine wash of said textiles; and
C) removing the textiles from the washing machine.

The present invention further relates to such methods wherein the actuating the washing machine to perform the rinse and spin program comprises a human intervention of pressing a button, rotating a rotary dial to a preset position, selecting on a touch-screen, or combinations thereof or otherwise by one or more tactile or remote-control communication steps interacting with the washing machine or a control panel thereof to initiate the program.

The present invention further relates to such methods wherein the rinse and spin program is provided by an appliance manufacturer in a washing machine for purposes other than for laundering textiles with a detergent and wherein said washing machine forms part of an installed base of domestic washing machines.

The present invention further relates to such methods wherein the rinse and spin program is provided by an appliance manufacturer as a detergentless program for purposes other than laundering, said purposes being selected from rinsing and spinning clothes which have already been hand-washed, for purposes of allergy control or for other purposes not encompassing laundering soiled fabrics.

The present invention further relates to such methods wherein the rinse and spin program comprises the washing machine operating to complete a rinse, drain and spin at least once, and wherein no more than four rinses occur during execution of the program.

The present invention further relates to such methods wherein the rinse and spin program comprises the washing machine operating to complete a rinse, drain and spin at least once, and wherein no more than two rinses occur during the program.

The present invention further relates to such methods which bypasses one or more sensors of said washing-machine.

The present invention further relates to such methods followed by a step of completing textile drying by machine drying in a tumble dryer, line drying or combination thereof.

The present invention further relates to such methods wherein the detergent composition is added into the drum of the domestic front-loading laundry washing machine by:

a) placing the detergent composition directly into the drum;

b) bypassing a sensor of the laundry washing machine;

c) first placing the detergent composition into a dispensing device and then placing the dispensing device into the drum; or

d) a combination thereof.

The present invention further relates to such methods wherein the detergent is added into the drum of the domestic front-loading washing machine without use of a dispensing drawer incorporated into said washing machine.

The present invention further relates to such methods wherein the detergent is added into the laundry washing machine in a dispensing device.

The present invention further relates to such methods wherein the dispensing device is selected from dosing cups, dosing balls, scoops and combinations thereof.

The present invention further relates to such methods wherein the textiles are substantially comprised of clothing.

The present invention further relates to such methods wherein the clothing comprises body-fitting garments.

The present invention further relates to a packaged product containing therein a laundry detergent composition, wherein the packaged product includes instructions for use, said instructions for use comprising instructions for dosing the detergent composition into the drum of a laundry washing machine and actuating a rinse and spin program.

The present invention further relates to such packaged products wherein the instructions for use further comprise additional instructions for dosing the detergent composition into the dispensing drawer and actuating a standard laundry program.

The present invention further relates to methods of marketing a laundry detergent composition wherein said method includes instructing consumers that the detergent composition can be used effectively to launder textiles by placing the detergent composition directly into the drum of a front-loading laundry washing machine and actuating the rinse and spin program.

The present invention further relates to use of a detergent composition in the rinse and spin program of a front-loading laundry washing machine wherein the composition and textiles are added directly to a drum of the front-loading laundry washing machine and the rinse and spin program is actuated.

The present invention further relates to such methods wherein the detergent composition delivers a total amount of soluble surfactant dosed per rinse and spin program wash of from about 0.1 to 1.3 grams/liter of wash water used.

The present invention further relates to such methods wherein the total amount of soluble surfactant dosed per rinse and spin program wash is from about 0.2 to about 0.8 grams/liter of wash water used.

The present invention also relates to a detergent composition exhibiting at least one of the following characteristics:

a) the total amount of linear surfactants (“TLS”) and the amount of Fatty Acids (“FA”), all expressed in grams/liter of wash water used, obeys the following relationship:

(TLS−2.5×FA)<0.20 grams/liter; and/or

b) the composition delivers between 0.01 and 0.2 grams/liter of a polydimethylsiloxane or derivative thereof;

wherein the detergent composition is in association with a set of instructions to consumers for the use of the detergent composition in the rinse and spin program of a front-loading laundry washing machine.

The present invention further relates to such methods wherein the detergent composition further comprises from about 0.05 to about 0.30 grams/liter of wash water, of detergent chelants, polymers, and mixtures thereof.

The present invention further relates to such methods wherein the detergent composition comprises less than 0.01 grams/liter wash water of detergent enzymes.

The present invention further relates to a textile laundering kit, comprising;
a) at least one inner package;
b) at least one outer package;

wherein the at least one inner package comprises a detergent composition according to those set forth above, and wherein the at least one outer package comprises instructions for consumer use, further wherein said instructions provide written or visual cues to the consumer indicating that the detergent composition may be used in the rinse cycle of a horizontal axis washing machine to provide textile benefits.

The present invention further relates to use of a detergent composition comprising a surfactant and exhibiting at least one of the following characteristics:

a) the total amount of linear surfactants (“TLS”) and the amount of Fatty Acids (“FA”), all expressed in grams/liter of wash water used, obeys the following relationship:

(TLS−2.5×FA)<0.20 grams/liter; and/or
b) the composition delivers between 0.01 and 0.2 grams/liter of a polydimethylsiloxane or derivative thereof;
   for washing textiles in a rinse and spin cycle of a domestic front-loading laundry washing machine.

The present invention further relates to a kit comprising a laundry pretreater and a rinse-cleaning laundry detergent for washing textiles in a rinse and spin cycle of a domestic front-loading laundry washing machine. The present invention further relates to such a kit for washing textiles in a domestic front-loading laundry washing machine without reliance on any mainwash laundry detergent.

### BRIEF DESCRIPTION OF THE DRAWINGS

FIG. 1. is a schematic drawing of the control panel of a domestic front-loading laundry washing machine model Miele W986 sold by Miele in the Netherlands and Belgium. Switch on using the white button to the left. Rotate the dial to “Extra spoelen”.

FIG. 2 is a schematic drawing of the control panel of a domestic front-loading laundry washing machine model Miele W989i WPS sold by Miele in the UK. Switch on using the white button on the left. Rotate the dial to “Separate Rinse”.

FIG. 3(a) is a schematic of drawing of the control panel of a domestic front-loading laundry washing machine model Indesit WIE 167 sold by Indesit

FIG. 3(b) is a portion from the user manual of WIL 163 S and includes a symbol identifying the rinse and spin cycle. The rinse and spin cycle is labeled “Rinse” and is identified as a “partial program”.

FIG. 4(a) is a schematic of drawing of the control panel of a domestic front-loading laundry washing machine model Baumatic BWD 12 sold by Baumatic.

FIG. 4(b) is a portion of instructions for use of Baumatic BWD 12 explaining how to implement two different rinse and spin programs varying in spin speed. Higher speeds are used for less delicate textiles while lower speeds are used for more delicate textiles.

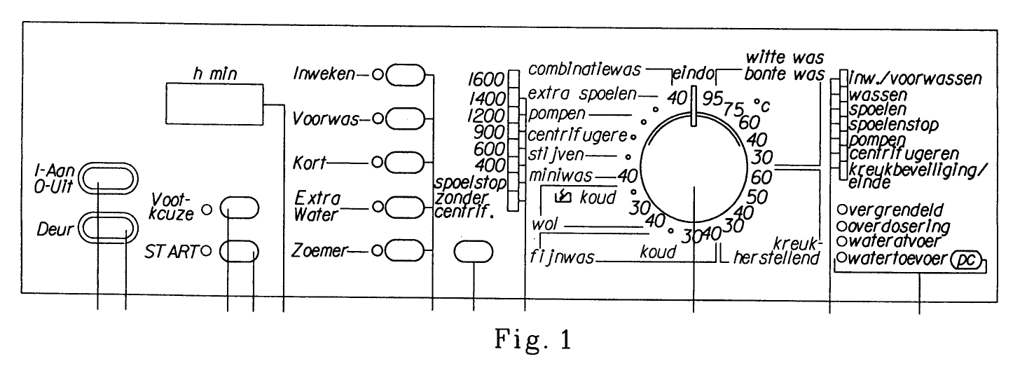

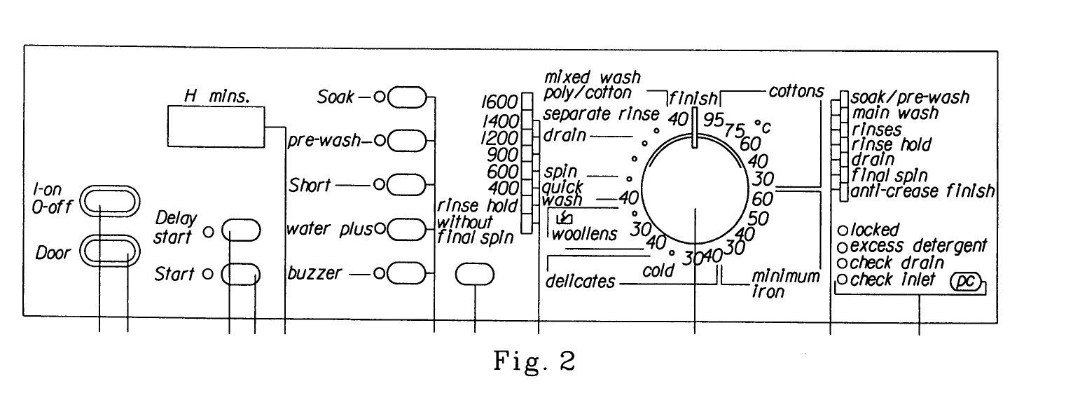

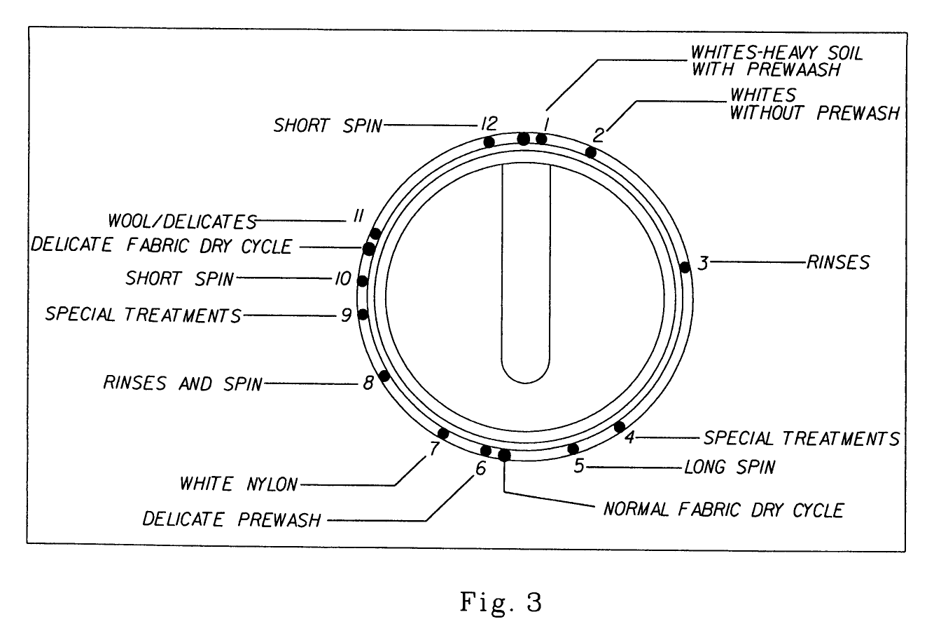

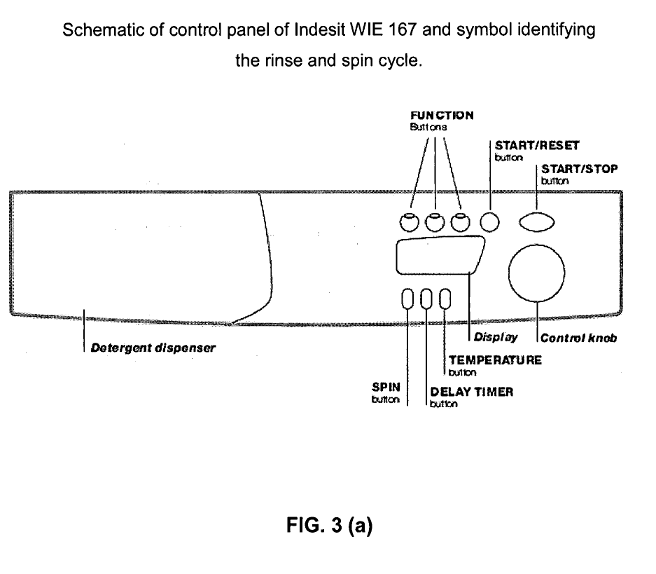

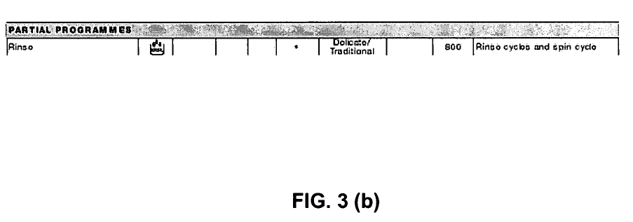

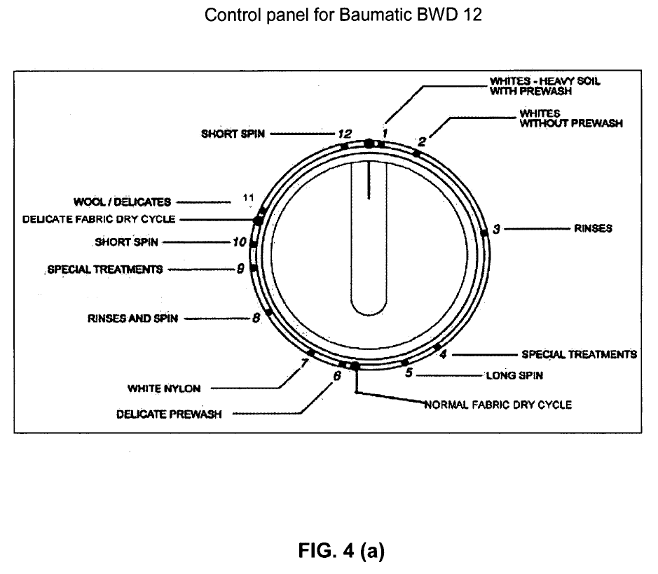

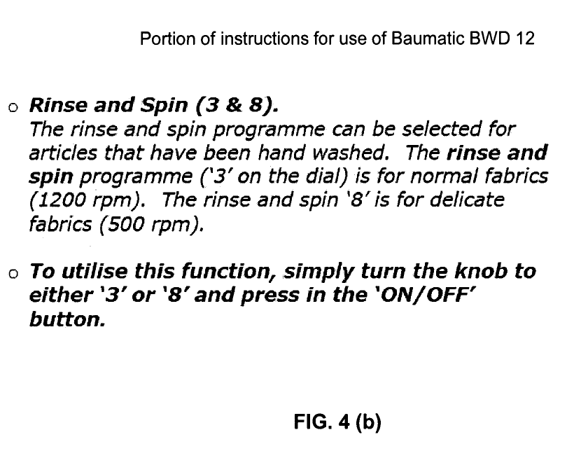

Different programs can be selected by human actuation.

### DETAILED DESCRIPTION OF THE INVENTION

Domestic laundry washing machines in general include those having “top loading” and “front loading” configurations. In the “top loading” configuration, still widely available in North America and parts of Asia, clothes are placed in a vertically-mounted cylinder, where they are agitated in wash water using a propeller-like agitator or impeller.

Top-loading laundries washing machines have some advantages over front-loading laundry washing machines in that they complete washing much faster, are easier to load without bending down, cost less, and allow clothes to be removed more easily at intermediate stages of the program—e.g., if the user desires to remove delicate clothes before they are spun. On the other hand they use more water and tend to be energy inefficient.

The “front loading” configuration is predominant in Europe and the Middle East and was developed for various reasons, in particular so as to use less water than top-loaders, so as to better exploit enzymes, and so as to reduce energy usage. Industry reports of experts advising on washing machine design, for example “Washing Machines: Long Term Efficiency Targets” by Van Holsteijn and Kemna, Delft, May 1995, appear to be consistent with a trend toward the introduction of longer and longer washing programs in domestic front-loading laundry washing machines in Western Europe until about 2004 based on perceptions that (i) this was the right way to save water and energy, and (ii) consumers would accept the long wash times provided that limits of e.g., more than two hours, were not exceeded. However, consumers were not happy with this trend.

In domestic front-loading laundry washing machines, a cylinder, also often called a “drum” is used, and it is placed “horizontally”. In practice “horizontal” can include variations of many degrees off-horizontal. The terms “horizontal axis” or “front-loading” in common usage in reality identify washing machines which are other than agitator, impeller or nutator types and which typically do not involve substantially immersing all the laundry in a bath. Loading is through a door at the front of the machine. Agitation during the wash is provided by continuous or, more typically, back-and-forth rotation of the drum, and by gravity. The clothes are lifted up by paddles or vanes attached to the inside of the inner drum, and are then dropped or allowed to fall back under force of gravity when the lifting motion of the vanes ceases intermittently. This motion flexes the weave of the fabric and forces water and detergent solution through the clothes load. Such front-loaders typically do not in general immerse a complete bundle of textiles, rather textiles, such as bundles of clothes, lie (at most) partially immersed in the drum. Often there is so little water that the clothes do not appear to be immersed at all. After one or more rinses, the laundry is spun at high speed to dewater it, helping save heater energy in the drying step. The drying step is typically carried out in a domestic clothes dryer, although some integrated washer-dryers are known. Although rarer, there is also a variant of domestic horizontal axis laundry washing machine that is loaded from the top, through a small door in the circumference of the drum. These washing machines usually have a shorter cylinder and are therefore smaller. Such laundry washing machines are included in the term “front-loading” or “horizontal axis” for the present purposes since the wash mechanism is substantially identical.

As used herein, the term “domestic front-loading laundry washing machine” in general refers to laundry washing machines sized for domestic use, i.e., having load ratings of up to about 10 kg, more typically up to about 6 kg dry laundry, and having the most common configuration offered for sale in Western Europe in the period 1985-2005. Such washing machines are other than those having a vertical axis and capable of completely immersing a fabric bundle in a wash bath.

### Method of Laundering Textiles

The methods of laundering textiles set forth herein are useful in “European-style” domestic front-loading laundry washing machines (from Western Europe but also including North American High Efficiency (HE) appliances). Domestic front-loading laundry washing machines in the established base of appliances in western Europe include models manufactured by Miele, Bosch/Siemens, Indesit, Dyson, Zanussi and many others and are available under a range of brand names including Candy, Smeg, Baumatic and others.

As used herein, “laundering textiles” generally refers to a process of laundering domestic textiles which have been worn or otherwise used. Laundering removes odors and at least some soil, perspiration, and the like. At the same time, depending on consumer desires, laundering can be performed with detergents according to the invention which are particularly adapted to these desires, for example laundering can be performed with a “free” formulation which is free from perfumes; a “non-bio” formulation which is free from enzymes, a “color care” formulation which includes, for example, dye transfer inhibitors or dye fixatives, and the like. “Laundering textiles” for the present purposes is not intended to include heated laundering in long wash programs such as the 60 degree cotton program as described in IEC 60456 Ed 4.0.

In laundering textiles methods as defined herein, the user may choose to pretreat localized stains such as blood, grass, tomato sauce and the like using a commercially available stain pen, wipe, applicator or other pretreater. Accordingly, products for use with the present methods can be kits which include a combination of a pretreater and a rinse-cleaning detergent as defined and illustrated herein. Surprisingly it is possible to use such a kit to completely eliminate use of a mainwash detergent. Alternately consumers may use variations of the method of the invention by combining any known marketed pretreatment detergent or laundry additive in a pretreatment step with rinse-cleaning methods involving short rinse and spin cycles as taught herein.

Additionally, the methods set forth herein are carried out without a normal washing program such as 30° C., 60° C., or 90° C., programs for cotton or synthetics, although the same item of laundry may experience different wash programs and/or detergents after wearing, and in previous to wearing laundering or subsequent launderings. Without being limited by theory, the methods set forth herein are intended to be either stand-alone textile laundering methods or can include a stain pre-treater or subsequent textile enhancer step, in any event, they avoid lengthy front-loader washing machine standard laundering programs.

### Textiles

As used herein, “textiles” refers to clothing (such as, for example, shirts, sweaters, socks, pants, shorts, hats, gloves, jackets, coats, and the like), fabrics, linens (such as, for example; curtains, sheets, towels, duvet covers, blankets, bedding, pillowcases, and the like). In one embodiment, the textiles are clothing, i.e. articles of apparel for wearing on the body and do not include non-body fitting items such as washcloths, handkerchiefs, diapers or the like which typically require special laundering, e.g., with strong sanitizers or boil-washes, as is well known. In another embodiment, the clothing is comprised at least in part of wool fibers, silk fibers, or combinations thereof.

### Detergent Composition

In one embodiment, detergent compositions useful herein include those that are in any liquid, gel, paste or rapidly soluble solid form, are low-foaming, are capable of evenly dispersing or dissolving in cold water, are capable of reducing surface tension, and at least to some extent operate to suspend dirt in the wash. Liquids and gels are preferred.

Single units of liquid or gel form laundry detergent composition packaged within water-soluble or water-insoluble pouches (commonly referred to as “liquid unit dose” detergents) may also be used in the methods set forth herein.

Liquid unit dose type detergents may be provided in a single-dose water-soluble pouch. In one embodiment, the pouch is made of a film comprising a water-soluble polyvinylalcohol (PVA) copolymer such as the one described in patent application US 2006/0035042. Other commercially available water soluble films, such as MONOSOL 8630, may be used to form such pouches.

Suitable detergent compositions for use herein generally comprise anionic and/or nonionic surfactants and are not substantially in the form of vesicular dispersions of cationic softeners, the latter being characteristic of laundry products sold as fabric conditioners rather than as cleaners.

Preferred rinse-cleaning detergent compositions for use with the present method comprise total soluble surfactant at levels suitable to provide concentrations of from about 0.1 gram per liter to about 1.3 grams per liter, more suitably from 0.2 grams per liter to no more than 0.8 grams per liter in the wash water of a rinse and spin program. As used herein, total soluble surfactant is defined as including linear or branched types of soluble surfactant but not including fatty acids. For purposes of illustration, the total soluble surfactant can be selected from anionic soluble surfactants such as the C8-C18 alkyl sulfates (AS), C8-C18 methyl ester sulfonates (MES), C8-C18 alkylpoly(ethoxy) sulfates (AES, SLES) any of which can be mixed and can be present as the acid form, sodium, potassium or C1-C4 alkanolammonium salt forms; nonionic soluble surfactants such as the known C8-C18 alcohol poly(alkoxylates) e.g., the C8-C18 alcohol poly(ethoxylates); alkylpolyglycosides (APG), single-chain cationic soluble surfactants such as the C8-C18 alkyltrimethylammonium halides, more particularly dodecyltrimethylammonium chloride or analogs thereof wherein one or more hydroxyethyl moieties replace one or more N-methyl substituents, or mixtures thereof. Nonlinear soluble nonionic surfactants useful herein include Lial, Guerbet and/or Dobanol types. Linear soluble surfactants can include alicyclic types, which preferably comprise no branch of more than three carbon atoms in length. Such lightly branched types include the “mid-chain branched” types described in commonly assigned patents of Daniel S. Connor. Other soluble surfactants useful herein include the linear and singly methyl-branched alkylbenzene sulfonates in the sodium, potassium or alkanolammonium form. Multiple branched alkylbenzenesulfonates such as ABS are less preferred owing to known problems with regard to biodegradation. Other soluble surfactants useful herein may include nonionic surfactants such as C10-C18 alcohol poly(ethoxylates) and their propoxy, butoxy or analog types comprising more than one source of alkoxylation, as it is known that such nonionic surfactants exhibit cloud point behavior but are soluble below the cloud point. In general, the soluble surfactant does not include dual long-chain cationic surfactants comprising more than about 20 carbon atoms—such surfactants are substantially water-insoluble at all wash temperatures used herein and are commonly used as fabric softeners.

Suitable low-foaming detergent compositions useful herein include those that incorporate ingredients such as; silicones, silicone/silica suds suppressors, fatty acids, low-foaming nonionic surfactants, e.g., those derived from branched feedstocks, or combinations thereof, for limiting foam.

In one embodiment, the detergent compositions used in the methods herein deliver good cleaning and a low suds level at the end of the method. Such compositions may contain soluble surfactants and optionally fatty acids or polydimethylsiloxane. These soluble surfactants may include linear or branched alkyl groups. Such compositions may also exhibit the following characteristics:

Total Soluble Surfactant Dosed

The detergent compositions herein may deliver a total amount of soluble surfactant dosed per rinse and spin program wash, from about 0.1 to about 1.3 grams/liter of wash water used. In one embodiment, the total amount of soluble surfactant dosed per rinse and spin program wash is from about 0.2 to about 0.8 grams/liter.

Delivered Ingredients

The detergent compositions useful in the methods herein may also exhibit at least one of the following characteristics:
1) The total amount of linear surfactants (“TLS”) and the amount of Fatty Acids (“FA”), all expressed in grams/liter of wash water used, obeys the following relationship:

(TLS−2.5×FA)<0.20 grams/liter; and/or

2) The composition delivers between 0.01 and 0.2 grams/liter of a polydimethylsiloxane or derivative thereof.

In alternate terms and without being limited by theory, the inventive methods set forth herein encompass a system wherein the total surfactant used is a combination of linear-only soluble surfactants combined with a suds suppression or foam control system selected from polydimethylsiloxanes. For the present purposes, “polydimethylsiloxane” can be selected from fabric softening polydimethylsiloxanes, polydimethylsiloxanes in compounded form such as silicone/silica compounded mixtures, and any variations thereof.

In one embodiment, the compositions further contain from about 0.05 to about 0.30 grams/liter (of rinse and spin program wash water), of detergent chelants, polymers, and mixtures thereof. In one embodiment, the compositions contain less than 0.01 grams/liter wash water of detergent enzymes.

The amount of detergent composition used in the methods of the present invention can vary widely depending on its dilution and can for example be from about 20 ml to about 200 ml. The detergent composition can be weighed or measured by volume.

Optional Ingredients

The detergent compositions useful in the methods of the present invention may also contain fabric care ingredients such as softening-through-the-wash ingredients, antistatic agents, anti-wrinkling agents, dye transfer inhibitors, color fixatives, anti-abrasion agents, bleach scavengers, fabric de-pilling agents, deposition aids for fabric care actives, deposition aids for perfume ingredients, perfume microcapsules, pro-perfumes, visual additives (such as pearlescence, dyes, etc.), and similar traditional detergent additives. Moreover enzymes can be used in the present compositions, in which case commercial enzyme preparations sold by Novozymes, Genencor, Danisco and others are especially useful. Levels of enzyme in formulations are specified as levels of commercial detergent enzyme in percentages by weight unless otherwise specifically indicated. Dosages can vary in accordance with known norms. The present compositions also include enzyme-free variations.

Other detergent compositions useful in the methods of the present invention also include ingredients having antibacterial, antifungal, antiviral or other anti-pathogenic effects. Suitable examples of such active agents include peroxyacids, such as peracetic acid or equilibrium peracid mixtures; 4-chloro-3,5-dimethylphenol (e.g., as defined by CAS # 88-04-0); tosylchloramide sodium; chlorhexidine; cetrimide; o-phenylphenol; triclosan; octyl decyl dimethylammonium chloride; dimethyl benzylammonium chloride or other antibacterially active quaternary ammonium salts; sources of water-soluble silver ions; antipathogen-active essential oils or components thereof; and mixtures thereof. It should be understood and appreciated that when laundering lightly soiled clothing using the method of the present invention, the combination of soluble surfactant with antipathogen-active agents is especially useful.

### Measuring Device

When placing the detergent composition in the drum of the washing-machine, the detergent composition can be poured or otherwise measured out of a dosing cap, dosing ball, dosing cup or the like onto the textiles; or the measuring device and the detergent composition can simply be placed together with the textiles in the washing machine. In one embodiment, the appropriate dosage of detergent composition may be enclosed within a water-soluble film “pouch” or envelope (or multiples thereof) and placed directly into the drum of the washing machine. In another embodiment, the appropriate dosage of detergent composition may be enclosed within a single-dose package or two dual-dose packages that are opened and the contents poured into the drum.

Adding into a Domestic Front-Loading Washing Machine

The methods of the present invention include the step of adding into a domestic front-loading laundry washing machine having a rinse and spin program, at least one or more textiles in need of laundering and a detergent composition.

The detergent composition herein includes commercially available detergent compositions and may take the form of a liquid, paste, gel, mousse, powder, tablet, sachet or the like.

In one embodiment, the detergent composition is added directly into the drum or is added into the machine by means of a sensor bypass. Without being limited by theory, by adding this detergent composition directly into the drum or by utilizing a sensor bypass, it is possible to allow the detergent composition enough time to launder the textiles and still be removed by the later portion of the rinse and spin part of the program (such as by having two rinses, the detergent composition being added to the first “rinse” and acting as a washing portion of the program while the second rinse functions as a more typical rinse/removal part of the overall program).

Although many front-loading laundry washing machines have a dispensing drawer or cup integrated into the machine, this can be used but may not be preferred for use in the method according to the present invention as in many cases these dispensers do not release the composition into the drum effectively without utilizing a sensor bypass. Many front-loading machines have two dispensing drawers, one for laundry detergent and a second for fabric enhancing compositions. Without being limited by theory, if the detergent drawer is used in the methods of the present invention, the detergent composition may not be released sufficiently and/or early enough into the drum to provide enough cleaning in the beginning stages of the shorter “rinse and spin” program. Further without being limited by theory, if the fabric enhancer drawer is used in the methods of the present invention for dispensing the detergent composition, it will not be released until the very end of the rinse and spin program and therefore will not provide enough cleaning and may also undesirably leave detergent residue. If the machine has a sensor bypass capability, it may be possible to use one of the dispensing drawers and override what may be an undesirable dispensing timing, thus effectively dispensing the detergent at the beginning of the rinse and spin program.

The method includes an embodiment wherein the detergent composition is introduced into the laundry washing machine other than by means of a dispensing drawer of said washing machine, and an embodiment wherein the detergent composition is directly introduced into the laundry washing machine in a dispensing device. Without being limited by theory, this embodiment may be easier for consumers to implement with their existing laundry washing machine.

Suitable dispensing devices include dosing cups, dosing “balls”, scoops and the like, depending on the form of the detergent composition. Dosing cups, dosing balls and dosing caps which can be fitted to the cap of a liquid detergent container are preferred.

In one embodiment, a fabric softening composition (commonly referred to as “fabric enhancer” composition) is further added to the machine through the fabric enhancer dispensing drawer. In this embodiment, a first rinse can serve to launder while a second or additional rinse can serve to separately soften fabrics.

Washing Machine

Domestic “horizontal-axis” or “front-loading” laundry washing machines useful herein are those meeting appliance industry standards, e.g., of the International Electrotechnical Commission, such as those commercially available from many manufacturers including Bosch, Indesit/Hotpoint, Whirlpool, Kenmore, LG, Frigidaire, Miele, and Maytag. The domestic laundry washing machines suitable herein are those also referred to as “European Style” washing machines or, in the US, “High Efficiency” washers. As used herein, “horizontal axis” means an axis within +/−45° of the horizontal plane

Domestic front-loading laundry washing machines herein are those in which the textiles are placed in a horizontal or inclined drum and partially immersed in the washing water, the mechanical action being produced by rotation of the drum about its axis, the movement being continuous or periodically reversed, and the machine having lifting vanes or similar protrusions to lift the laundry, as well as means for centrifuging or spin-extracting the laundry after washing at speeds of 400 rpm or above, more typically 800 rpm to 1400 rpm or higher, e.g., 2000 rpm. Such washing machines can additionally incorporate a tumble-dryer, in which case they are domestic front-loading washer-dryers.

Domestic front-loading washing machines herein are accordingly clearly distinguishable from agitator washing machines, impeller washing machines and nutator washing machines as described in IEC 60456 Ed. 4.0 which all employ substantially differing mechanisms.

The washing machines useful herein include an inner drum (when used without qualification the term “drum” herein refers to the inner drum) suited according to IEC 60456 Ed. 4.0 for rated capacities of from 2 to 10 kg dry cotton laundry, for example the inner drum may have a volume of 65 litres and other features such as lifting vanes and drum construction, e.g., perforation, according to the reference washing machine described in Annex A of IEC 60456 Ed. 4.0.

Such domestic front-loading laundry washing machines herein also include means for actuating the washing machine so as to conduct a rinse-and-spin program independently from another wash program.

As used herein, “rinse and spin program” refers to the action performed by a washing machine resulting in the at least partial filling of the drum; agitating (e.g., at least partially lifting the laundry, either periodically or continuously by means of vanes fitted to the drum); draining of the drum, spinning, in one embodiment at speeds of at least 200 rpm, in another embodiment above 800 rpm, so as at least partially remove water; and cycling through these steps at least one additional time.

The rinse and spin programs used in the present invention have a maximum duration from actuation until the washing machine halts (assuming no further actuation or action is taken by the operator), of from about 5 to about 40 minutes, in one embodiment from 7 to less than 30 minutes. In one embodiment the duration is from about 7 to about 17 minutes, alternatively is about 15 minutes.

Suitable temperatures for the wash and spin cycle are from about 5° C. to about 28° C. In any event, the rinse and spin program may be unheated.

The rinse and spin program can be variously identified on the control panel of the washing machine as a “rinse and spin”, “rinse”, and the like, provided that the rinse and spin program can be actuated independently from other programs which is commonly the case.

In one embodiment of the invention, the method involves sensor bypass. Certain washing machines comprise one or more sensors e.g., for foam levels, detergent dispensing, turbidity measurement during rinses, and the like. The invention includes methods which bypass one or more such sensors.

In one embodiment of the invention, the detergent manufacturer and appliance manufacturer collaborate to inform consumers that such a program is available on a particular washing machine and that a particular detergent is suitable for use.

In one embodiment of the invention, the utility of the method is communicated to consumers by non-retail means, such as by service technicians employed by appliance manufacturers or their representatives.

### Actuating the Washing Machine to Perform the Rinse and Spin Program

In the methods of the present invention, the washing machine is actuated to perform the rinse and spin program such that such rinse and spin program is not immediately preceded by a full washing cycle.

In one embodiment, the rinse and spin program comprises the washing machine operating to complete a rinse cycle at least once and no more than three times in succession.

In one embodiment, when the identified rinse and spin program is actuated, the machine responds to the actuation by performing two or more consecutive rinse cycles. In another embodiment, when the identified rinse and spin program is actuated, the machine responds to the actuation by performing three consecutive rinse cycles and then ceases operation until further input.

In one embodiment, the step of actuating the washing machine includes adjusting the mechanical action of the washing machine to the rinse and spin program. In a standard home laundry situation, such actuation of the washing machine is performed by a human.

In one embodiment, the horizontal-axis washing machines useful herein include an identified rinse and spin program having a corresponding push button, touch-screen selection, knob, dial, or combination thereof that may be used to actuating the setting. In one embodiment, the step of actuating the washing machine to perform the rinse and spin program includes human interaction with the washing machine by their pushing a button, turning a knob, turning a dial, selecting on a screen, or combinations thereof.

Removing the Textiles from the Drum of the Washing Machine

Any means for removing the textiles from the drum of the washing machine after the rinse cycle may be used in the methods of the present invention. Such removal may be completed without any additional laundering steps such as post-rinse, post treatment, a main laundry cycle, or combinations thereof, etc.

### Allowing the Textiles to Dry

Any means for drying the textiles may be used in the methods of the present invention. Such means for drying may include machine drying, air-drying (such as line drying) and combinations thereof.

In the methods of the present invention, it is intended that the textiles be subjected to no further cleaning processes until after further use or wearing. However, it is well within the methods of the present invention to use such post-refreshing treatments as spray-starch, perfumes, fabric softeners, stain pens (for treating spot stains) and combinations thereof.

### EXAMPLE I

### Method According to the Invention

Using a domestic front loading washing machine commercially available from Miele with the manufacturer's model number of W986 having multiple programs selectable by a user (including settings for Rinse and other settings), the following steps are taken:
1) Approximately 50 grams (measured either by weight or by volume equivalent) of one of the soluble low-foaming liquid laundry detergent selected from compositions 1A through 1C, having the formulas given in Table 1, are dispensed directly into the drum of the Miele W986.
2) Textiles are added to the drum including:
   a. 1 men's blue colored, size Medium city shirt in 100% cotton
   b. 1 women's dark colored, size Medium T-shirt in 100% linen
   c. 1 women's black, size Medium skirt in a blend of 70% polyester/5% cotton/5% elasthane
   d. 1 men's dark-colored, size Medium sport T-shirt in a 100% polyester-breathable microfiber.
3) The door of the washing machine is then closed.
4) The washing machine is then manually actuated by a human—turning the right-hand dial to the setting “Rinse”.
5) The Miele W986 then functions to operate the Rinse program.
6) Upon completion of the Rinse program, the door of the washing machine is opened, the textiles are removed, and are allowed to dry.

Upon drying, the textiles are found to have good odor.

### EXAMPLE II

### Method According to the Invention

The procedures of Example I are repeated except for using approximately 40 g of a detergent formulation found as Formula 2B in Table 2, below.

### EXAMPLE III

### Method According to the Invention

The procedures of Example I are repeated except for using approximately 50 g of Formula 2D from Table 2.

### EXAMPLE IV

### Method According to the Invention

The procedures of Example I are repeated except for using approximately 30 g of Formula 2A from Table 2.

### EXAMPLE V

### Method According to the Invention

The procedures of Example I are repeated except for using approximately 25 g of Formula 3C from Table 3.

### EXAMPLE VI

The procedures of Example 1 are repeated except replacing the Miele machine with a domestic front-loading laundry washing machine provided by Indesit in the UK as model WIE 167 having an unheated rinse and spin program. This includes 1^{st} rinse: 10 min; drain; 2^{nd} rinse 10 min, final spin 4 min, with a rinse and spin program total duration of 26 min.

The low-foaming liquid detergent 2A of Table 2 is used at a weight of 50 g.

### EXAMPLE VII

The procedure of Example I is repeated except for replacing the Miele machine with a domestic front-loading laundry washing machine provided by Baumatic in the UK as model BWD-12 and rinse and spin program 3.

### EXAMPLE VIII

The procedure of Example I is repeated except for replacing the Miele machine with a domestic front-loading laundry washing machine provided by Baumatic in the UK as model BWD-12 and rinse and spin program 8.

### EXAMPLE IX

The procedures of Example I are repeated except replacing the Miele machine with a domestic front-loading laundry washing machine provided by Indesit in the UK as model WIE 167 having an unheated rinse and spin program; and using Ariel Liquitabs. This includes 1^{st} rinse: 10 min; drain; 2^{nd} rinse 10 min, final spin 4 min, with a rinse and spin program total duration of 26 min.

The low-foaming liquid detergent 1A of Table 1 is commercially available in unit dose form as for example, ARIEL LIQUITABS, which are pre-packaged liquid laundry detergent inside of polyvinylalcohol sachets and have a weight of about 50 g. In this example, a sachet is cut with a knife, the detergent is poured out into a plastic dosing cup of the type sold with liquid laundry detergents, and the detergent and cup are placed directly into the drum of the washing machine with the textiles.

In all the foregoing examples, the rinse-cleaned textiles are found to be substantially clean, good-smelling, in good condition, and lacking visible detergent residues.

### EXAMPLE FORMULATIONS

TABLE 1
Compositions 1A, 1B, and 1C are all examples of liquid detergent formulations
useful in the methods of the present invention and deliver both good cleaning
and acceptable low suds levels at the end of the wash. Compositions 1D, 1E
and 1F are comparative examples of liquid detergent formulations which are
unsuitable for use in the methods of the present invention as they do not deliver
both good cleaning and low suds level at the end of the wash.

| | 1A | 1B | 1C | 1D | 1E | 1F |
|---|---|---|---|---|---|---|
| Ingredients | % by weight | | | | | |
| Alkylbenzene sulfonic | 1.2 | 7.8 | — | 10.6 | | — |
| acid | | | | | | |
| Sodium C12-14 alkyl | 6.8 | — | 0.2 | 1.4 | 0.3 | — |
| ethoxy sulfate | | | | | | |
| C12-14 alkyl 7-ethoxylate | 0.2 | 0.3 | | | 13.8 | — |
| C12 alkyl polyglucoside | | | | | 2.0 | — |
| C12 alkyl dimethyl amine | — | — | 1.6 | | — | — |
| oxide | | | | | | |
| C12-14 alkyl | — | — | 1.0 | | — | — |
| hydroxyethyl dimethyl | | | | | | |
| ammonium chloride | | | | | | |
| Total linear surfactants | 8.2 | 8.1 | 2.8 | 12 | 16.1 | 0 |
| C12-15 alkyl 3-ethoxylate | | | 0.3 | | | — |
| C13-15 alkyl 8-ethoxylate | 4.0 | 6.1 | 9.6 | 2.9 | — | — |
| Total branched | 4.0 | 6.1 | 9.9 | 2.9 | — | 0 |
| surfactants | | | | | | |
| Total soluble surfactants | 12.2 | 14.2 | 12.7 | 14.9 | 16.1 | 0 |
| C12-18 Fatty acid | 2.6 | 2.6 | — | 1.9 | 0.5 | — |
| Triethanolamine, bis | | | | | 1.9 | — |
| (C16-18 alkyl diester) | | | | | | |
| N,N dimethyl | | | | | | |
| methylsulfate | | | | | | |
| Bis (C16-18 alkyl | | | | | | 12 |
| oxyethyl) N,N, dimethyl | | | | | | |
| ammonium chloride | | | | | | |
| Citric acid | 2.6 | 2.6 | 3.0 | — | 0.05 | 0.1 |
| Enzymes | 0.5 | 0.8 | — | — | — | — |
| Buffers | To pH | To pH | To pH | To pH | To pH | To pH |
| | 8.0 | 8.0 | 8.0 | 8.0 | 5.5 | 3.0 |
| Minors, solvents, | To 100 | | | | | |
| stabilizers, water | | | | | | |
| Recommended DOSAGE | 50 g | 50 g | 50 g | 50 g | 50 g | 50g |
| (g) | | | | | | |
| Wash volume (liters) | 12 | | | | | |
| Grams/liter soluble | 0.51 | 0.59 | 0.53 | 0.62 | 0.67 | 0 |
| surfactants | | | | | | |
| TLS (Grams/liter total | 0.34 | 0.34 | 0.12 | 0.50 | 0.67 | 0 |
| linear surfactants) | | | | | | |
| FA (Grams/liter fatty | 0.11 | 0.11 | — | 0.079 | 0.021 | 0 |
| acids) | | | | | | |
| TLS - 2.5*FA | 0.065 | 0.065 | 0.12 | 0.30 | 0.62 | 0 |
| (Grams/liter) | | | | | | |
| Cleaning performance | good | good | good | good | good | poor |
| Residual suds level in the | very low | very low | very low | high | high | very low |
| last rinse | | | | | | |

TABLE 2
Examples of liquid detergent compositions useful
in the methods of the present invention.

| | 2A | 2B | 2C | 2D | 2E |
|---|---|---|---|---|---|
| Ingredients | % by weight | | | | |
| Alkylbenzene sulfonic acid | 23 | 9.6 | 3.0 | 1.5 | 1.5 |
| Sodium C12-14 alkyl ethoxy | | | 12.0 | 6.8 | 3.5 |
| sulfate | | | | | |
| C12-14 alkyl 7-ethoxylate | 19 | 1.2 | | | |
| Total linear surfactants | 42 | 9.6 | 15 | 8.3 | 5.0 |
| C13-15 alkyl 8-ethoxylate | — | — | 4.0 | 4.0 | — |
| Total branched surfactants | — | — | 4.0 | 4.0 | 4.0 |
| Total soluble surfactants | 42 | 10.8 | 17.3 | 12.3 | 5.0 |
| C12-18 Fatty acid | 16 | 6.8 | 2.6 | 2.6 | 2.6 |
| Citric acid | 1.7 | 1.5 | 2.6 | 2.6 | 2.6 |
| Protease enzyme | 0.2 | 0.1 | — | — | — |
| Amylase enzyme | 0.05 | — | — | — | — |
| Mannanase enzyme | 0.05 | — | — | — | — |
| Ethoxylated | 0.5 | — | — | — | — |
| Polyethyleneimine | | | | | |
| Ethoxylated | 3.5 | — | 2.0 | 2.0 | 4.0 |
| Polyethyleneimine, | | | | | |
| quaternized, sulfated | | | | | |
| Hexamethylene tetramine | — | 0.9 | 1.0 | 1.0 | 1.0 |
| pentaphosphonic acid | | | | | |
| Hydroxyethane diphosphonic | 0.7 | — | — | — | — |
| acid | | | | | |
| Total polymers + chelants | 4.7 | 0.9 | 3.0 | 3.0 | 5.0 |
| Fluorescent Whitening Agent | 0.2 | 0.08 | — | — | — |
| Montmorillonite clay | — | 3.3 | — | — | — |
| Solvents (1,2 propandiol, | 13 | 7.0 | 2.0 | 2.0 | 2.0 |
| ethanol), stabilizers | | | | | |
| Boric acid | — | 1.0 | — | — | — |
| Perfume | 1.7 | 0.7 | 1.0 | 1.0 | 1.0 |
| Buffers (sodium hydroxide, | To pH 7.5 | To pH 7.5 | To pH 7.5 | To pH 7.5 | To pH 7.5 |
| Monoethanolamine) | | | | | |
| Silicone suds suppressor Q2- | | | 0.5 | | |
| 3302 ex Dow Corning | | | | | |
| Water | To 100 | | | | |
| Recommended DOSAGE (g) | 30 g | 40 g | 50 g | 50 g | 50 g |
| Recommended wash water | 12 liters | | | | |
| (liters) | | | | | |
| Grams/liter soluble surfactants | 1.05 | 0.36 | 0.72 | 0.51 | 0.21 |
| TLS (Grams/liter total linear | 1.05 | 0.36 | 0.62 | 0.34 | 0.21 |
| Surfactants) | | | | | |
| FA (Grams/liter fatty acids) | 0.40 | 0.22 | 0.11 | 0.11 | 0.11 |
| TLS-2.5*FA | 0.05 | −0.19 | 0.34 | 0.06 | −0.06 |
| Grams/liter silicone compound | | | 0.02 | | |
| Grams/liter of polymers + | 0.12 | 0.03 | 0.12 | 0.12 | 0.21 |
| chelants | | | | | |
| Grams/liter enzymes (raw | 0.007 | | | | |
| materials) | | | | | |

TABLE 3
Examples of liquid and gel detergent compositions
useful in the methods of the present invention.

| | 3A | 3B | 3C | 3D | 3E | 3F |
|---|---|---|---|---|---|---|
| Ingredient | % by weight | | | | | |
| Alkylbenzene sulfonic acid | 1.5 | 1.5 | — | 1.5 | 7.5 | 3.5 |
| Sodium C12-14 alkyl ethoxy | 6.8 | 8.8 | 12.5 | 6.8 | 2.3 | — |
| sulfate | | | | | | |
| C12 alkyl dimethyl amine | — | — | 1.0 | — | — | — |
| oxide | | | | | | |
| C12-14 alkyl dimethyl | — | — | 3.0 | — | — | — |
| ammonium chloride | | | | | | |
| Total linear surfactants | 8.3 | 10.3 | 16.5 | 8.3 | 9.8 | 3.5 |
| C13-15 alkyl 8-ethoxylate | 4.0 | 4.0 | — | 4.0 | 1.5 | 2.5 |
| Total soluble surfactants | 12.3 | 14.3 | 14.7 | 12.3 | 11.3 | 6.0 |
| C12-18 Fatty acid | 2.5 | 2.5 | — | 2.5 | 2.5 | — |
| Citric acid | 2.5 | 2.5 | 3.0 | 2.5 | 2.5 | 7.0 |
| Protease enzyme | 0.05 | — | — | — | — | — |
| Ethoxylated | 0.7 | 1.0 | — | 0.7 | — | — |
| Polyethyleneimine | | | | | | |
| Ethoxylated | 2.5 | 2.0 | 1.7 | 0.7 | 0.7 | 3.5 |
| Polyethyleneimine | | | | | | |
| quaternized, sulphated | | | | | | |
| Hydroxyethane diphosphonic | 0.3 | 0.5 | 0.7 | | — | 0.5 |
| acid | | | | | | |
| Total polymers + chelants | 3.5 | 3.5 | 2.4 | 1.4 | 0.7 | 4.0 |
| Fluorescent Whitening Agent | 0.10 | — | — | 0.10 | — | — |
| Cationic hydroxyethyl | 0.5 | 0.2 | — | 0.2 | 0.3 | — |
| cellulose | | | | | | |
| Polydimethylsiloxane 20,000 | — | 3.0 | 5.0 | — | — | — |
| cst | | | | | | |
| Sucrose fatty acid esters | — | — | — | 4.5 | — | — |
| Lupasol (Polyethyleneimine | — | — | 0.3 | — | — | — |
| ex BASF) | | | | | | |
| Solvents (1,2 propandiol, | 1.7 | — | 3.2 | | 2.5 | 1.0 |
| ethanol), stabilizers | | | | | | |
| Boric acid | 2.0 | 1.0 | — | — | — | — |
| Perfume | 0.5 | 1.5 | 0.4 | 1.0 | 1.0 | 1.0 |
| Perfume microcapsules | — | — | — | — | 0.5 | — |
| Silicone Suds suppressor | — | | — | 0.2 | 0.5 | — |
| Buffers (sodium hydroxide, | To pH 7.5 | | | | | To pH 3.0 |
| Monoethanolamine) | | | | | | |
| Water | To 100 | | | | | |
| Recommended DOSAGE (g) | 40 g | 40 g | 25 g | 30 g | 50 g | 40 g |
| Recommended wash water | 12 liters | | | | | |
| (liters) | | | | | | |
| Grams/liter soluble | 0.41 | 0.48 | 0.31 | 0.31 | 0.48 | 0.20 |
| surfactants | | | | | | |
| TLS (Grams/liter total linear | 0.33 | 0.34 | 0.34 | 0.21 | 0.41 | 0.12 |
| Surfactants) | | | | | | |
| FA (Grams/liter fatty acids) | 0.08 | 0.08 | — | 0.06 | 0.10 | — |
| TLS-2.5*FA | 0.13 | 0.14 | 0.34 | 0.09 | 0.16 | 0.12 |
| Grams/liter silicone | — | — | 0.10 | — | — | — |
| compound | | | | | | |
| Grams/liter of polymers + | 0.12 | 0.12 | 0.05 | 0.03 | 0.03 | 0.13 |
| chelants | | | | | | |
| Grams/liter enzymes (raw | 0.002 | — | — | — | — | — |
| materials) | | | | | | |

TABLE 4
Example of Liquid Composition enclosed within a single-dose
water-soluble pouch (Liquid Unit Dose), useful in the methods of
the present invention.
4A

| | % of Liquid |
|---|---|
| Ingredient | composition |
| Alkylbenzene sulfonic acid | 18 |
| C12-14 alkyl 7-ethoxylate | 22 |
| Total soluble surfactants | 40 |
| Total linear surfactants | 40 |
| C12-18 Fatty acid | 15 |
| Citric acid | 1.5 |
| Hexamethylene tetramine pentaphosphonic acid | 0.5 |
| Fluorescent Whitening Agent | 0.08 |
| Polydimethylsiloxane, 20,000 cst | 4.0 |
| Solvents (1,2 propandiol, ethanol), stabilizers | 17 |
| Perfume | 1.5 |
| Buffers (sodium hydroxide, Monoethanolamine) | 11 (to pH 7.5) |
| Water | To 100 |
| Recommended DOSAGE (g) | 25 grams |
| Recommended wash water (liters) | 12 |
| Grams/liter soluble surfactants | 0.83 |
| TLS (Grams/liter total linear surfactants) | 0.83 |
| FA (Grams/liter fatty acids) | 0.31 |
| TLS-2.5*FA | 0.06 |
| Grams/liter silicone compound | 0.08 |

TABLE 5
Example of a foam detergent composition suitable for packaging in an
aerosol can, as described for instance in European Patent, EP 768371.
5A

| Ingredient | % by weight |
|---|---|
| C12-14 alkyl 7-ethoxylate | 6.0 |
| Alkenebenzene sulfonic acid | 6.0 |
| Total linear surfactants | 12 |
| C13-15 Alkyl 3-ethoxy sulfate | 18 |
| Total soluble surfactants | 30 |
| C12-18 Fatty acid | 15 |
| Citric acid | 1.5 |
| Hexamethylene tetramine pentaphosphonic acid | 0.5 |
| Ethoxylated Polyethyleneimine quaternized, sulphated | 3.0 |
| Fluorescent Whitening Agent | 0.08 |
| Solvents (1,2 propandiol, ethanol), stabilizers | 25 |
| Perfume | 1.3 |
| Buffers (sodium hydroxide, Monoethanolamine) | To pH 8.0 |
| Water | To 100 |
| Recommended DOSAGE (g) | 25 grams |
| Recommended wash water (liters) | 12 |
| Grams/liter soluble surfactants | 0.62 |
| TLS (Grams/liter total linear surfactants) | 0.25 |
| FA (Grams/liter fatty acids) | 0.31 |
| TLS-2.5*FA | 0.08 |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering textiles comprising the sequential steps of:
a) adding into a domestic front-loading laundry washing machine, wherein said washing machine has at least one rinse and spin program, at least:
i) one or more textiles; and
ii) a detergent composition;
b) actuating the washing machine to perform at least one rinse and spin program, wherein the actuation of such rinse and spin program is not preceded by a manual or machine wash of said textiles; and
c) removing the textiles from the washing machine.

2. A method according to claim 1 wherein actuating the washing machine to perform the rinse and spin program comprises a human intervention of pressing a button, rotating a rotary dial to a preset position, selecting on a touch-screen, or combinations thereof or otherwise by one or more tactile or remote-control communication steps interacting with the washing machine or a control panel thereof to initiate the program.

3. A method according to claim 2 wherein said rinse and spin program is provided by an appliance manufacturer in a washing machine for purposes other than for laundering textiles with a detergent and wherein said washing machine forms part of an installed base of domestic washing machines.

4. A method according to claim 3 wherein the rinse and spin program is provided by an appliance manufacturer as a detergentless program for purposes other than laundering, said purposes being selected from rinsing and spinning clothes which have already been hand-washed, for purposes of allergy control or for other purposes not encompassing laundering soiled fabrics.

5. A method according to claim 1 wherein the rinse and spin program comprises the washing machine operating to complete a rinse, drain and spin at least once, and wherein no more than two rinses occur during the program.

6. A method according to claim 1 which bypasses one or more sensors of said washing-machine.

7. A method according to claim 1 wherein the detergent composition is added into the drum of the domestic front-loading laundry washing machine by:
a) placing the detergent composition directly into the drum;
b) bypassing a sensor of the laundry washing machine;
c) first placing the detergent composition into a dispensing device and then placing the dispensing device into the drum; or
d) a combination thereof.

8. A method according to claim 1 wherein the detergent is added into the drum of the domestic front-loading washing machine without use of a dispensing drawer incorporated into said washing machine.

9. A method according to claim 9 wherein the detergent is added into the laundry washing machine in a dispensing device selected from dosing cups, dosing balls, scoops and combinations thereof.

10. A method according to claim 1 wherein the textiles are substantially comprised of clothing comprising body-fitting garments.

11. A packaged product containing therein a laundry detergent composition, wherein the packaged product includes instructions for use, said instructions for use comprising instructions for dosing the detergent composition into the drum of a laundry washing machine and actuating a rinse and spin program.

12. A packaged product according to claim 11 wherein the instructions for use further comprise additional instructions for dosing the detergent composition into the dispensing drawer and actuating a standard laundry program.

13. A method of marketing a laundry detergent composition wherein said method includes instructing consumers that the detergent composition can be used effectively to launder textiles by placing the detergent composition directly into the drum of a front-loading laundry washing machine and actuating the rinse and spin program.

14. Use of a detergent composition in the rinse and spin program of a front-loading laundry washing machine wherein the composition and textiles are added directly to a drum of the front-loading laundry washing machine and the rinse and spin program is actuated.

15. Use according to claim 18 wherein the laundry composition is selected from low-foaming liquid or gel laundry compositions.

16. A method according to claim 1 wherein the detergent composition delivers a total amount of soluble surfactant dosed per rinse and spin program wash of from about 0.1 to 1.3 grams/liter of wash water used.

17. A detergent composition exhibiting at least one of the following characteristics:
a) the total amount of linear surfactants (“TLS”) and the amount of Fatty Acids (“FA”), all expressed in grams/liter of wash water used, obeys the following relationship:
(TLS−2.5×FA)<0.20 grams/liter; and/or
b) the composition delivers between 0.01 and 0.2 grams/liter of a polydimethylsiloxane or derivative thereof;
wherein the detergent composition is in association with a set of instructions to consumers for the use of the detergent composition in the rinse and spin program of a front-loading laundry washing machine.

18. A detergent composition according to claim 17 wherein the detergent composition further comprises from about 0.05 to about 0.30 grams/liter of wash water, of detergent chelants, polymers, and mixtures thereof.

19. A detergent composition according to claim 18 wherein the detergent composition comprises less than 0.01 grams/liter wash water of detergent enzymes.

20. Use of a detergent composition comprising a surfactant and exhibiting at least one of the following characteristics:
a) the total amount of linear surfactants (“TLS”) and the amount of Fatty Acids (“FA”), all expressed in grams/liter of wash water used, obeys the following relationship:
(TLS−2.5×FA)<0.20 grams/liter; and/or
c) the composition delivers between 0.01 and 0.2 grams/liter of a polydimethylsiloxane or derivative thereof;
for washing textiles in a rinse and spin cycle of a domestic front-loading laundry washing machine.
